(19) United States
(12) Patent Application Publication
(10) Pub. No.: US 2011/0079310 A1
(43) Pub. Date: Apr. 7, 2011

(54) MOUNTABLE TRAVERSING CARRIAGE

(76) Inventor: Walter F. Thompson, Ontario (CA)

(21) Appl. No.: 12/710,892

(22) Filed: Feb. 23, 2010

Related U.S. Application Data
(60) Provisional application No. 61/249,137, filed on Oct. 6, 2009.

(51) Int. Cl. F16L 55/168; B23P 11/00

(52) U.S. Cl. 138/99; 29/428

(57) ABSTRACT

A mountable traversing carriage for traversing a workpiece, method of traversing a workpiece, performing an operation on a workpiece and manufacturing a mountable traversing carriage is described. The carriage has first and second end plates coupled to first and second clamps for attaching the end plates to a workpiece, with a connector for connecting the first end plate to the second end plate. A mid plate is movably mounted to the connector and arranged between the first and second end plates. A saddle, having a third clamp, is mounted to the mid plate. The carriage is moved along the workpiece via a traversing device attached to one of the end plates for advancing the mid plate along the workpiece when the first and second clamps are engaged. The carriage advances the first and second end plates along the workpiece via the traversing device when the third clamp is engaged.

### CROSS REFERENCE TO PROVISIONAL APPLICATION

This application is based upon and claims the benefit of priority from Provisional U.S. Patent Application 61/249,137 filed on Oct. 6, 2009, the entire contents of which are incorporated by reference herein.

### TECHNICAL FIELD

The present disclosure is directed to a device for traversing an object. More specifically, the device is for traversing a workpiece, in which the device is capable of having a second device mounted thereon for performing an application to the workpiece. This disclosure is also directed to a method of manufacturing a mountable traversing device and its use thereon for performing work on a workpiece.

### BACKGROUND

Traversing carriages have been known in the art. Carstensen describes in U.S. Pat. No. 7,535,187 how single axis traversing mechanisms are built within support structures that convey process applications or measurement devices across the web in processes such as papermaking, nonwoven production, steel rolling and a multitude of other processes producing sheet type materials. For example, in the papermaking process, cross web traversing devices carry high pressure water jets to clean the serpentine belt material used to convey the paper sheet through the press and/or dryer section(s) of the papermaking machine. However, these devices do not disclose a means for maintaining radial stability while traversing the linear object. Nor are the carriages sufficiently robust for mounting heavy objects.

One desired application of the mountable traversing carriage of the present application is in the field of strengthening pipes. By way of example, a steel strip laminate technology has been developed which wraps a metallic composite pipe in Martensitic ultra-high strength thin steel strips. The strips are pre-formed and helically wound around the pipe to form a laminated high strength-reinforcing layer providing the pipe's hoop strength. These are bonded using an epoxy adhesive which is cured in an IR oven. The pipe may then be coated with any suitable pipeline coating material, as required by a service condition. The system has the advantages that it is considerably (60%) thinner and lighter than conventional linepipe products because of the beneficial strength-to-weight ratio. However, one disadvantage is that a system has not been developed to helically wrap the pipe while the pipe is in service.

The prior art also identifies the use of a composite wrap to place a layer over natural gas pipelines without taking them out of service. (http://www.epa.gov/gasstar/documents/ll_compwrap.pdf) Composite wrap is a permanent, cost-effective pipeline wrapping technology. Composite wrap can be performed on an operating pipeline without taking it out of service. This technique is quick and generally less costly than other options, and it provides pressure-containing capability of the pipe when properly installed.

Composite wrap can serve as an alternative to the traditional pipeline repair practices such as pipeline replacement or the installation of full-encirclement steel split sleeves. Compared to these traditional practices, composite wrap repairs are generally less expensive, time consuming, and labor intensive. In the case of pipeline replacement, composite wrap repair has additional advantages of avoiding customer service interruptions and eliminating methane emissions associated with the venting of the damaged pipeline.

Using composite wrap as an alternative to pipeline replacement often saves enough gas to pay back repair costs immediately. Natural Gas STAR™ reported completing 2 to 65 composite wrap repairs per year on pipelines 10″ and larger, saving 526 thousand cubic feet (Mcf) to 27,500 Mcf of natural gas per repair. Between 1993 and 1999, this technique saved 106,133 Mcf by choosing composite wrap over pipeline replacement. However, this composite wrap is labor intensive, requiring several human operators to operate the machine.

PipeStream, Inc. of Houston, Tex. has identified a method to introduce steel outside the original pipe wall (presented at a conference in Pittsburgh, Pa. on Oct. 19-22, 2009 that states as follows: “In-Hab and Ex-Hab: putting the steel back into pipelines). These solutions may be used to reduce the hoop stress in a pipe wall when population growth reclassifies a particular location as a high-consequence area, allowing an operator to maintain maximum allowable operating pressure and throughput. The external surface of a pipeline can be over-wrapped with continuous steel coil to add wall thickness and pressure capacity: this is external rehabilitation, or Ex-Hab.” See: http://www.pipestream.com/x200_summary.pdf.

However, it appears that the Ex-Hab method of PipeStream also requires a plurality of human operators. In addition, the device requires a wide swath of material to be removed from around the pipe, increasing labor costs.

### SUMMARY

To overcome the above mentioned problems, the present disclosure is directed toward a mountable traversing carriage for traversing a workpiece and performing an operation on a workpiece. The carriage has a first end plate coupled to a first clamp for selectively attaching the first end plate to the workpiece and a second end plate coupled to a second clamp for selectively attaching the second end plate to the workpiece, with a connector for connecting the first end plate to the second end plate. The carriage further has a mid plate movably mounted to the connector and arranged between the first end plate and the second end plate. A saddle, having a third clamp, is mounted to the mid plate. The carriage is moved along the workpiece via a traversing device attached to one of the end plates for advancing the mid plate along the workpiece when the first clamp and second clamp are locked onto the workpiece. The carriage advances the first and second end plates along the workpiece via the traversing device when the third clamp is locked onto the workpiece, and the first and second clamps are not locked onto the workpiece.

The disclosure is also directed toward a method for traversing a workpiece with a mountable traversing carriage. The method comprises the steps of placing a mountable traversing carriage on the workpiece. The carriage, as described above, comprises a first end plate coupled to a first clamp, a second end plate coupled to a second clamp, a connector for connecting the first end plate to the second end plate, a mid plate movably mounted to the connector and arranged between the first end plate and the second end plate, and a saddle mounted to the mid plate and having a third clamp.

After placing the carriage on the workpiece, the first and second end plates are selectively attached to the workpiece by activating the first and second clamps, respectively. A traversing device is then used to propel the mid plate along an axis of the workpiece. At the desired time or distance traversed by the mid plate, the third clamp is selectively attached to the workpiece and then the first and second clamps are detached from the workpiece. The traversing device then propels the first and second end plates along the axis of the workpiece, while maintaining a position of the mid plate. By repeating this procedure, the carriage is capable of continuously traversing along the workpiece.

The disclosure is also directed toward a method of manufacturing a mountable traversing carriage. The method comprises connecting a first end plate having a first clamp, a second end plate having a second clamp, and a mid plate having a third clamp with a connector. The mid plate is positioned between the first end plate and the second end plate along the axis of the connector. The first end plate is equipped with a traversing device for advancing the mid plate along a workpiece when the first clamp and second clamp are locked onto the workpiece. The traversing device is also capable of advancing the first and second end plates along the workpiece when only the third clamp is locked onto the workpiece.

Furthermore, the disclosure is directed to a method for repairing a section or multiple sections of pipe without necessitating removal of the section or sections from the entirety of the pipe. This allows for a pipe to continue operation during repair, thereby reducing the time and expense associated with removal of a section of pipe, both in the time required to remove and transport the pipe, and in the lost productivity due to the removal of the pipe.

The method comprises mounting a mountable traversing carriage as discussed above with a wrapping device. In one embodiment, the wrapping device comprises a winder for rotating around the pipe and a strip pad equipped with a quantity of strip material attached to the winder. The carriage is then stabilized on to the pipe by selectively attaching the first and second end plates to the pipe via a clamping mechanism. The mid plate then traverses along the pipe by activating the traversing device. In one embodiment, the wrapping device is mounted to a saddle that is attached to the mid plate, which advances along the pipe with the mid plate. During traversal of the pipe, the winder winds the strip material around the pipe, the strip material being fed to the wrapping device via the strip applicator. One or more tape pads are equipped with a quantity of metallic strip or composite tape attached to said winder. In addition, a canister and spray device for treating the pipe or the wrapping material prior to wrapping it onto the pipe. In this way, the pipe may be repaired while still in operation.

Additional advantages and other features of the present disclosure will be set forth in part in the description which follows and in part will become apparent to those having ordinary skill in the art upon examination of the following or may be learned from the practice of the disclosure.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1 is an elevated view of the mountable traversing carriage according to one embodiment of the present disclosure.

FIG. 2 is an elevated view of the mountable traversing carriage of FIG. 1 attached to a workpiece according to one embodiment of the present disclosure.

FIG. 3 is an elevated view of the mountable traversing carriage of FIG. 1 showing advancement of the mid plate and saddle along the workpiece.

FIG. 4 is an elevated view of the mountable traversing carriage of FIG. 1 showing advancement of the mid plate and saddle along the workpiece.

FIG. 5 is an elevated view of the wrapping device in the closed position according to another embodiment of the present disclosure.

FIG. 6 is an elevated view of the wrapping device in the open position according to another embodiment of the present disclosure.

FIG. 7 is an elevated view of the carriage with wrapping device of FIG. 5 mounted on the saddle according to another embodiment of the present disclosure.

FIG. 8 is an elevated view of the wrapping device of FIG. 5 showing advancement with the mid plate and saddle along the workpiece.

FIG. 9 is an elevated view of the wrapping device of FIG. 5 showing further advancement of the mid plate and saddle along the workpiece.

FIG. 10 is an elevated view of the end plates of the carriage of FIG. 9 further advanced along the workpiece.

FIG. 11 is an elevated view of the end plates of the carriage of FIG. 9 advanced further along the workpiece.

FIG. 12 is a top structural diagram of a mountable traversing carriage equipped with wrapping device according to another embodiment of the present disclosure.

FIGS. 13A-B are close up views of the mountable traversing carriage and wrapping device of FIG. 12.

FIG. 14 is an elevated view of the clamps and saddle in the open position according to another embodiment of the present disclosure.

### DETAILED DESCRIPTION

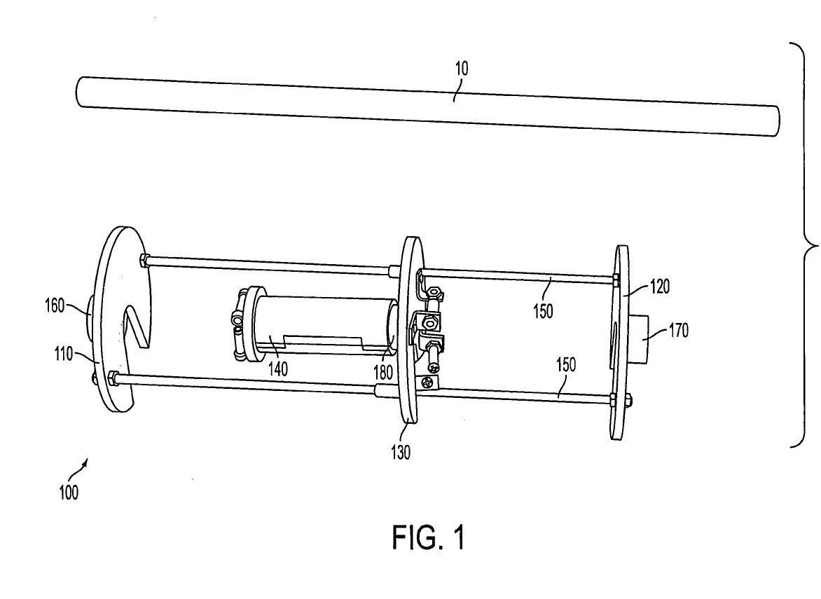

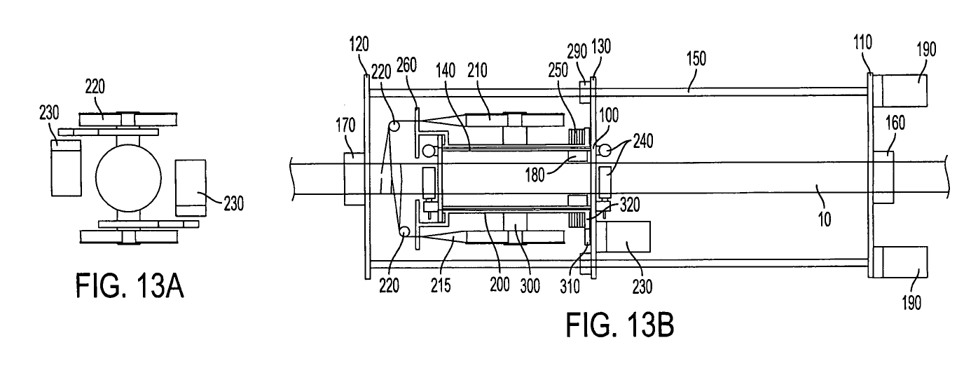

FIG. 1 shows a mountable traversing carriage 100 for performing an operation on a workpiece 10 and traversing the workpiece 10. The carriage 100 has a first end plate 110 coupled to a first clamp 160 for selectively attaching the first end plate 110 to the workpiece 10 and a second end plate 120 coupled to a second clamp 170 for selectively attaching the second end plate 120 to the workpiece 10, with a connector 150 for connecting the first end plate 110 to the second end plate 120. The carriage 100 is also equipped with a mid plate 130 movably mounted to the connector 150 and arranged between the first end plate 110 and the second end plate 120. A saddle 140, having a third clamp 180, is mounted to the mid plate 130. The carriage 100 is moved along the workpiece 10 via a traversing device. In one embodiment, for example, motors 190, as shown in FIG. 13B, are attached to the first end plate 110 on two connectors 150. However, other embodiments can utilize only one connector aligned above the workpiece 10 above the linear axis of the workpiece 10.

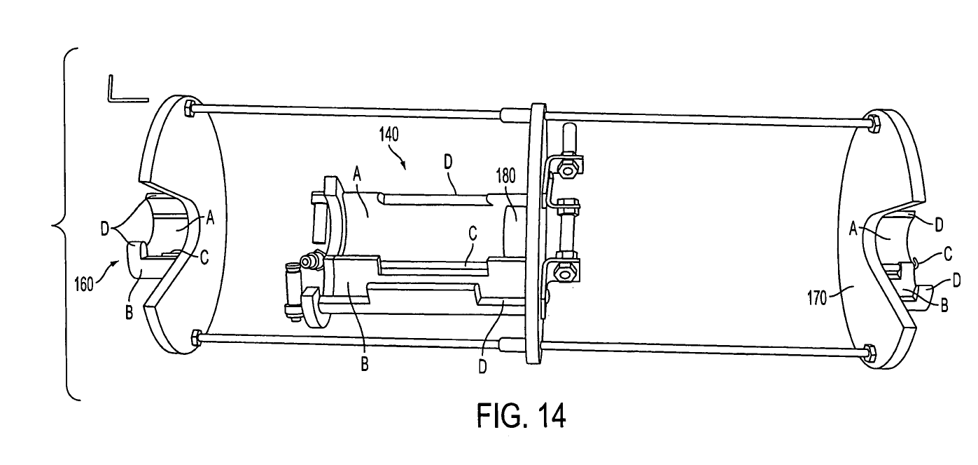

It is a desired property of the present disclosure to perform an operation upon a workpiece while not removing or disturbing the intended function of the workpiece. The mountable traversing carriage of the present disclosure must be able to be mounted on and removed from a workpiece without necessitating the removal, adjustment, or other manipulation of the workpiece. In one embodiment of the present disclosure, this feature is achieved by having the various elements of the carriage able to reversibly attach to the workpiece. As is shown in FIG. 14, the first clamp 160, the second clamp 170, and the saddle 140 connected to a third clamp 180 are each comprised of a first mounting section A and a second mounting section B. Each mounting section has a first linear edge C and a second linear edge D. The first linear edges C of the first A and second B mounting sections are joined along a first common linear axis such that the mounting sections A, B are hinged together. By means of the hinge structure, the mounting sections A, B are able to open and close.

The first and second mounting sections are removably joinable along a second common linear axis formed along the second linear edges of the first and second mounting sections. Upon joining the first mounting section to the second mounting section along the second common linear axis, i.e., closing the clamps, the first clamp 160, the second clamp 170, and the saddle 140 and third clamp 180 each form an inner circumference. This inner circumference is adjustable to coordinate with an outer circumference of the workpiece 10.

These the inner circumferences of the clamps and saddle are adjustable such that the first clamp 160, the second clamp 170, and the saddle 140 and the third clamp 180 may be selectively attached, i.e., reversibly locked, to the workpiece 10 in order to stabilize the carriage on the workpiece. Any means known in the art that can selectively attach the clamps to the workpiece without damaging the workpiece may be used. One example of a clamping mechanism used in the certain embodiments of the present disclosure is an actuator, such as a Duff Norton™ linear actuator.

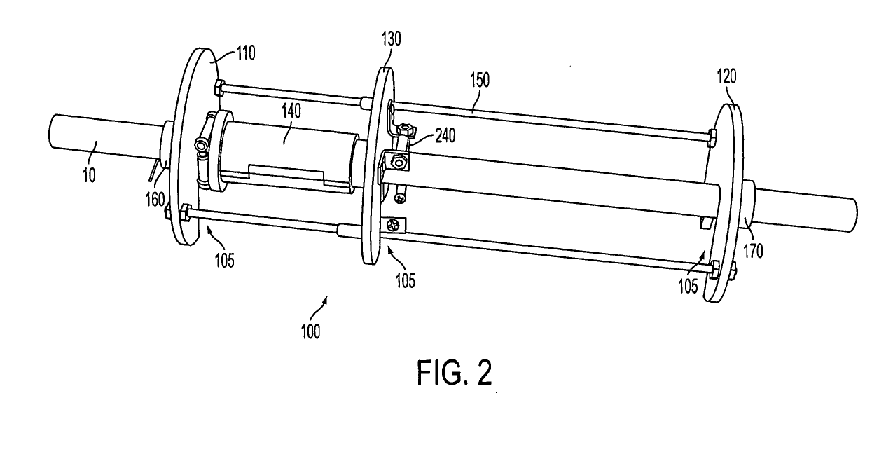

FIGS. 2-4 show the operation of the carriage on a workpiece. As can be seen in FIG. 2, the carriage 100 is mounted on the workpiece 10 by aligning wedge-shaped cutout portions 105 of the first 110 and second 120 end plates and the mid plate 130, with the workpiece 10. The clamps and saddle must be in the open position while mounting the end plates and mid plate. After mounting the carriage, the clamps and saddle are closed around the workpiece 10 as described above.

Then, to begin traversal of the mid plate along the workpiece, the first clamp 160 and second clamp 170 are selectively attached to the workpiece 10. FIG. 2 shows an initial position of the first 110 and second 120 end plates in the locked position and mid plate 130 in unlocked position.

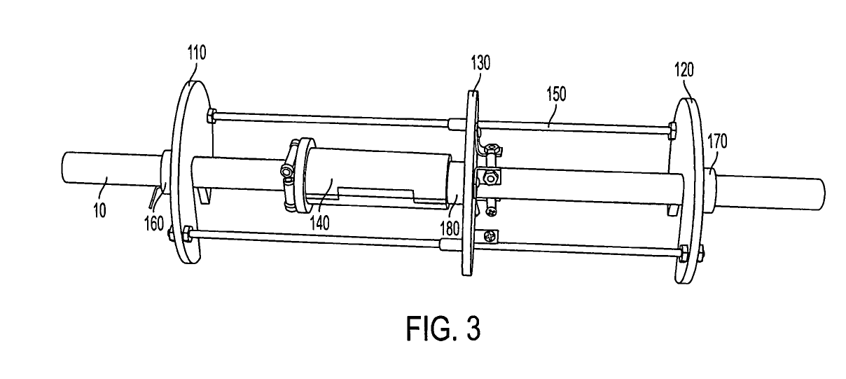

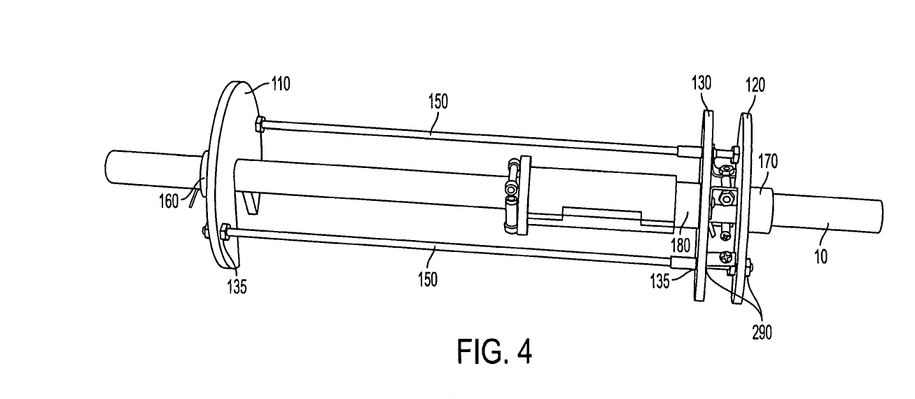

FIG. 3 shows the carriage as it is advanced along the mid plate 130 along the workpiece 10 by utilization of the traversing device (not shown). FIG. 4 shows the mid plate 130 at the end point of advancement. As is shown, the mid plate 130 abuts the second end plate 120. At this point, in order to continue traversing the carriage 100 along the workpiece 10, the third clamp 180 is locked onto the workpiece 10, followed by unlocking of the first 160 and second 170 clamps. The third clamp 180 should be locked before unlocking the first 160 and second 170 clamps in order to maintain rotational stability.

In one embodiment, the connector 150 comprises a screw thread or an Acme screw. In this embodiment, the mid plate 130 comprises a threaded hole 135 for engaging the screw thread 150 and secured via a′ball nut 290. In this embodiment, the motor 190 (as shown in FIG. 13B) rotates the screw thread 150 along a linear axis of the screw thread 150. As the screw thread 150 rotates, the mid plate 130 traverses along the workpiece 10 when the first clamp 160 and second clamp 170 are locked onto the workpiece 10. In order for the end plates to traverse the workpiece 10, the first clamp 160 and second clamp 170 are disengaged and the third clamp 180 is locked onto the workpiece 10 while rotating the screw thread 150 with the motor 190. Other means of advancing the end plates 110, 120 and mid plate 130 along the connector 150 can also be utilized. For example, a hydraulic piston can be utilized with a linearly-shaped connector, a pulley system, or other known devices in the art for traversing an object can be used.

One feature of the present disclosure is the ability to equip the mountable traversing carriage with a device for performing a function to, or in the proximity of, the work piece. The carriage 100 contains the saddle 140 for carrying a device for performing a function. The functions performed by the device can include painting the workpiece, cleaning the workpiece, a sensor for analyzing or observing the workpiece or the environment surrounding the workpiece, a carrier for dispensing objects along the workpiece, or the like. The present disclosure is not limited to the examples provided herein.

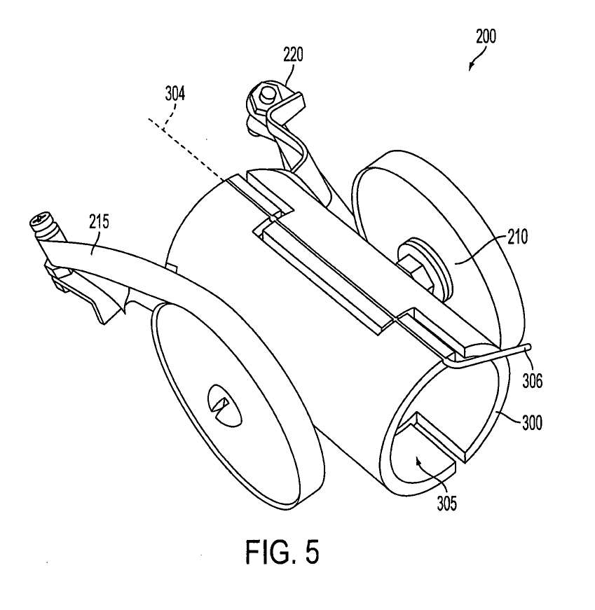

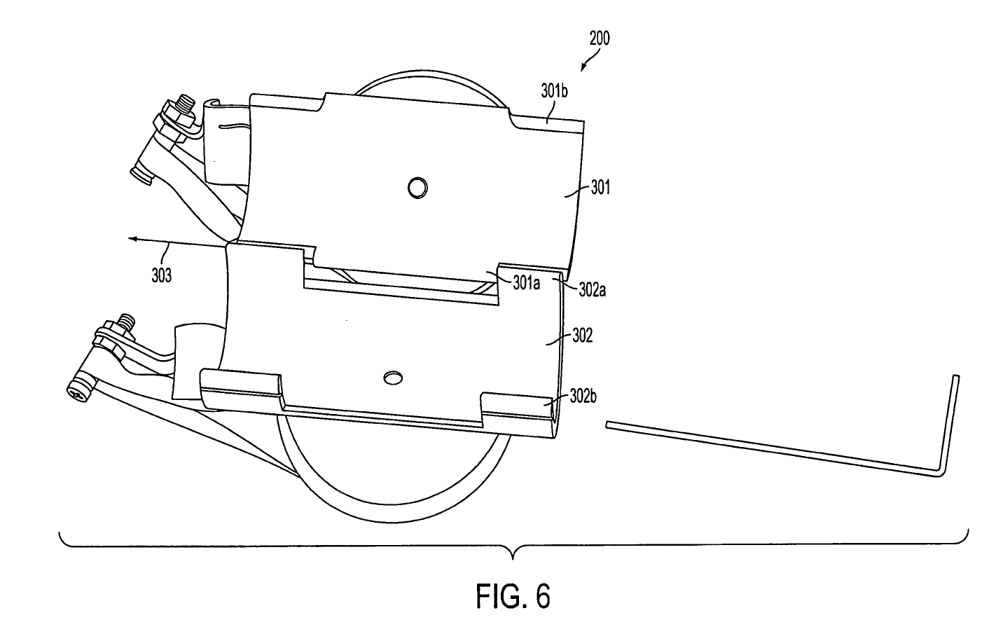

One specific function of an embodiment of the present disclosure is a pipe refurbishing device. FIG. 5 shows the pipe-wrapping device in the closed position and FIG. 6 shows the pipe-wrapping device 200 in the open position. In this embodiment, the winder 300 is comprised of a first mounting section 301 and a second mounting section 302, each mounting section having a first linear edge 301a, 302a and a second linear edge 301b, 302b. The first linear edge 301a of the first mounting section 301 and the first linear edge 302a of the second mounting section 302 are joined along a first common linear axis 303. The first mounting section 301 and the second mounting section 302 are removably joinable along a second common linear axis 304 formed along the second linear edge 301b of the first mounting section 301 and the second linear edge 302b of the second mounting section 302, such that, upon joining the first mounting section 301 and the second mounting section 302 along the second common linear axis 304, the winder forms an inner circumference 305. The inner circumference 305 is structured to conform to the outer circumference of the saddle 140. The first mounting section 301 and the second mounting section 302 may be joined together by a locking pin 306. This attachment mechanism is applicable to other mountable objects. Other known means to secure the winder known in the art may also be used. Other methods of equipping the saddle with the pipe refurbishing device, or any other device can include lockable mounting pins, snaps, strapping cables or other methods for reversibly attaching an object to another object.

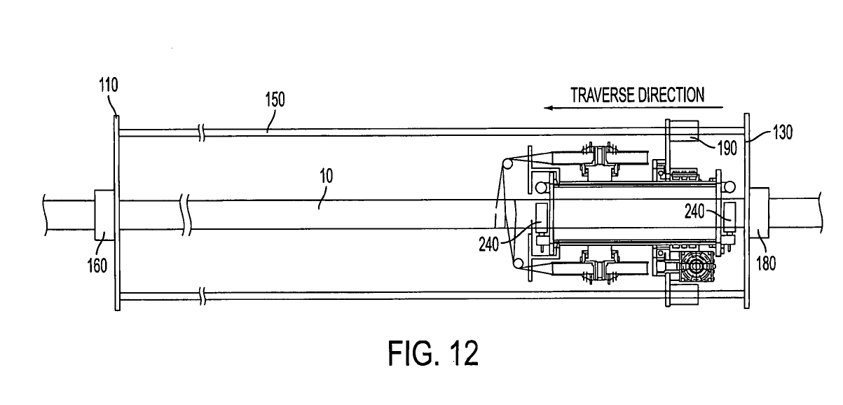

FIGS. 12 and 13A-B show a technical view of the pipe-wrapping device 200 for mounting on a saddle. The pipe-wrapping device 200 comprising the winder 300 is equipped with a strip applicator 210. The winder 300 is operated with a drive pinion 310 and drive gear 320. Electrical slip rings 250 operate to convert power from stationary to rotating. The strip applicator 210 feeds a strip 215 for covering the pipe to the pipe via strip guide rolls 220 and a tooling plate 260. A strip applicator motor and reducer 230 controls the output of the strip 215 onto a pipe 10 as well as maintains a tension on the strip 215 to accurately align the strip 215 on the pipe 10. Adjustable saddle support rollers 240 maintain and support the carriage 100 on the pipe 10. The adjustable saddle support rollers 240 are also shown in FIG. 2.

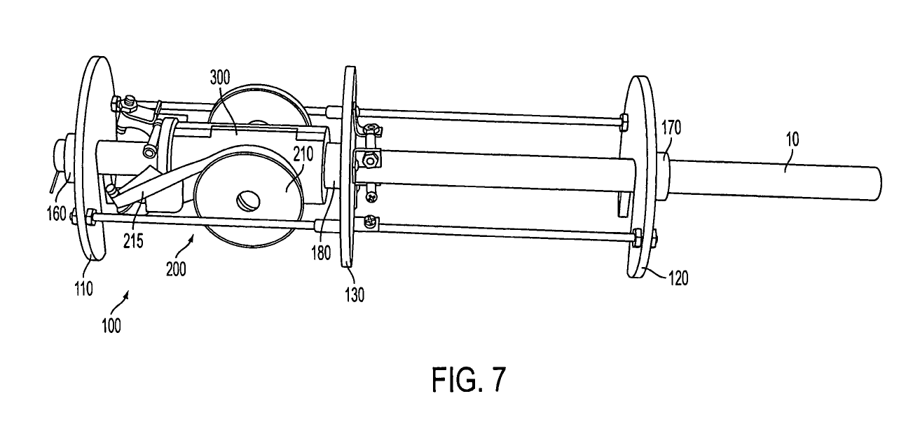

FIGS. 7-11 show the operation of the mountable traversing carriage 100 equipped with the wrapping device 200 according to one embodiment of the present disclosure.

FIG. 7 shows an initial position of the carriage 100 mounted on the pipe 10 with the wrapping device 200 mounted on the saddle 140 of the carriage 100. The first clamp 160 and second clamp 170 are in the locked position to prevent radial movement of the carriage on the pipe 10. Radial movement of the carriage about the pipe can lead to inaccurate application of the strip 215 to the pipe 10. The third clamp 180 is in the unlocked position to allow for the mid plate 130 and saddle 140, equipped with the wrapping device 200, to traverse the pipe 10 upon operation of a traversing device.

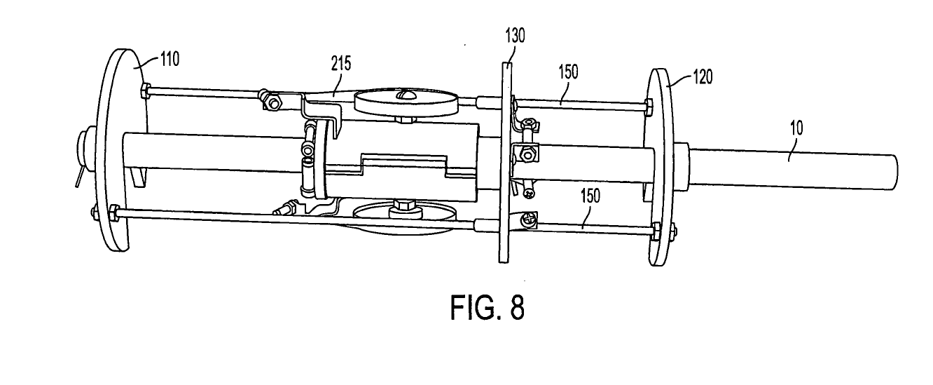

FIG. 8 shows the wrapping device further along the pipe 10. As is shown, the wrapping device of this embodiment rotates about the axis of the pipe to apply the strip 215 to the pipe. The wrapping device rotates around the axis on a bronze split bearing 295, as shown in FIG. 13B.

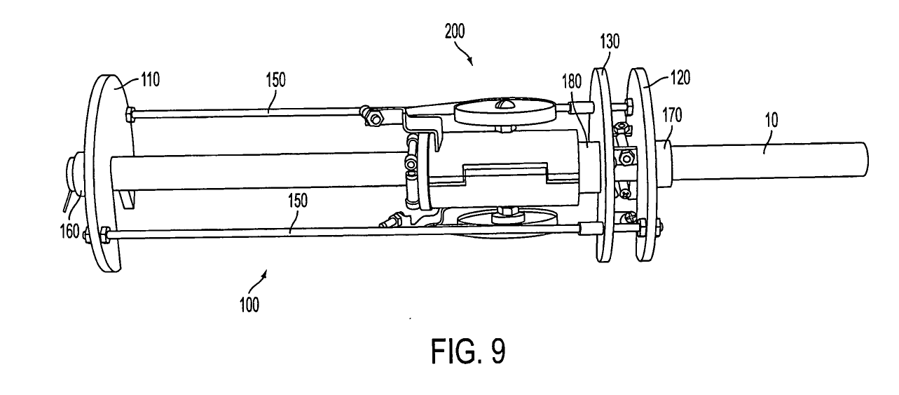

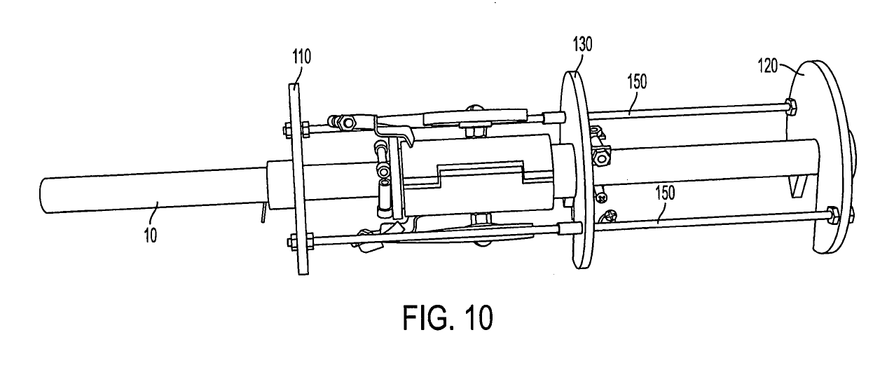

FIG. 9 shows the wrapping device 200 at the end of the stroke of the carriage 100. At this point, the third clamp 180 is locked onto the workpiece 10, followed by unlocking of the first 160 and second 170 clamps. The motor (not shown) is then reversed to rotate the ball screws 150 to advance the first end plate 110 and second end plate 120 in the same direction along the axis of the pipe 10. FIG. 10 shows the first and second end plates 110, 120 further along the pipe 10.

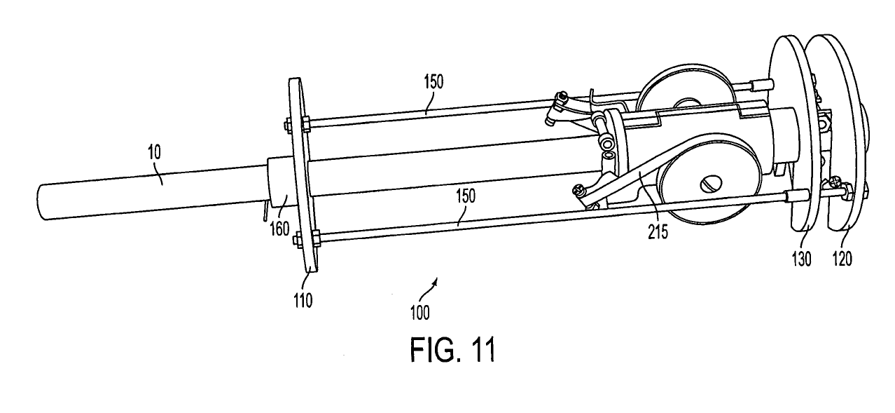

FIG. 11 shows the repeat of the traversing of the mid plate 130 along the pipe 10. As is clear, the figures are merely representative of a certain length of pipe. However, the carriage 100 is designed to traverse any distance of pipe. The movable carriage 100 of this disclosure is uniquely structured to allow the wrapping to be endless in that the wrapping can be joined, by welding the end of wrapped strip 215 to the beginning of the new strip. The unique structure of the saddle 140 and the clamps 160, 170 allow the wrapping device 200 to maintain the wrap in a secure tension position such the wrap 215 can be endless by the above joining of an old wrap end to a new wrap end. This is accomplished by the above described structure that allows the carriage 100 to be transversely moved along the work piece in sequential manner while the wrapping is maintained at the appropriate tension. While a metal wrap is provided for an example, other types of wrapping such as fiberglass, polymer, including nylon or the like, insulation material wrappings may similarly used. Further, the saddle structure may allow the use of adhesives, fillers, glue or other fluid compositions to be applied to the wrapping or during the wrapping process.

The carriage 100 of the present disclosure may be manufactured according to methods commonly known in the art. In one embodiment, the method comprises connecting a first end plate 110 having a first clamp 160, a second end plate 120 having a second clamp 170, and a mid plate 130 having a third clamp 180 with a screw 150. Typically, such as shown in FIG. 2, the carriage 100 will comprise two screws 150 situated on the equatorial plane of the carriage, parallel to and on approximately same plane as the work piece 10. This positioning of the connectors 150 adds support to the carriage 100. In other embodiments, the connectors 150 can be positioned above and below the central axis of the workpiece 10, or only one screw 150 above the central axis of the workpiece 10. Other supports known in the art can also be used to connect the first end plate 110 and the second end plate 120.

The mid plate 130 is positioned between the first end plate 110 and the second end plate 120 along the axis of the screw 150. Then, the first end plate 110 is equipped with a traversing device 190 for advancing the mid plate 130 along the workpiece 10 when the first clamp 160 and second clamp 170 are locked onto the workpiece 10. The traversing device 190 is also capable of advancing the first and second end plates 110, 120 along the workpiece 10 when the third clamp 130 is locked onto the workpiece 10. Various materials known in the art to be suitable for machines may be used to construct the carriage 100.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can be practiced without resorting to the details specifically set forth. In other instances, well known processing structures have not been described in detail, in order not to unnecessarily obscure the present disclosure.

Only a few examples of the present disclosure are shown and described herein. It is to be understood that the disclosure is capable of use in various other combinations and environments and is capable of changes or modifications within the scope of the inventive concepts as expressed herein.

What is claimed is:

1. A mountable traversing carriage for performing an operation on a workpiece and traversing the workpiece comprising:
a first end plate coupled to a first clamp for rigidly attaching the first end plate to the workpiece;
a second end plate coupled to a second clamp for rigidly attaching the second end plate to the workpiece;
a connector for connecting the first end plate to the second end plate;
a mid plate movably mounted to the connector and arranged between the first end plate and the second end plate;
a saddle mounted to the mid plate and having a third clamp; and
a traversing device attached to one of the end plates for advancing the mid plate along the workpiece when the first clamp and second clamp are locked onto the workpiece, and for advancing the first and second end plates along the workpiece when the third clamp is locked onto the workpiece.

2. The mountable traversing carriage of claim 1, wherein the connector comprises a screw thread, and the mid plate comprises a threaded hole for engaging the screw thread, and
wherein the traversing device is a motor attached to one of the end plates, the motor being used for rotating the connector along a linear axis of the connector to cause the mid plate to traverse the workpiece when the first clamp and the second clamp are locked onto the workpiece, and to cause the end plates to traverse the workpiece when the third clamp is locked onto the workpiece.

3. The mountable traversing carriage of claim 1, wherein the saddle further comprises a mounting portion for mounting a device for performing the operation on the workpiece.

4. The mountable traversing carriage of claim 1, wherein the first clamp, the second clamp, and the saddle are each comprised of a first mounting section and a second mounting section, each mounting section having a first linear edge and a second linear edge,
wherein the first linear edge of the first mounting section and the first linear edge of the second mounting section are joined along a first common linear axis,
wherein the first mounting section and the second mounting section are removably joinable along a second common linear axis formed along the second linear edge of the first mounting section and the second linear edge of the second mounting section, such that, upon joining the first mounting section and the second mounting section along the second common linear axis, the first clamp, the second clamp, and the saddle each form an inner circumference, and
wherein the inner circumference is adjustable such that the first clamp, the second clamp, and the saddle may be reversibly locked onto the workpiece.

5. The mountable traversing carriage of claim 2, wherein the connector is a ball screw.

6. The mountable traversing carriage of claim 1, wherein the first end plate, the second end plate and the mid plate each have a wedge-shaped cutout portion for mounting the plates on the workpiece.

7. A method for traversing a workpiece with a mountable traversing carriage comprising the steps of:
1) placing the mountable traversing carriage on the workpiece, wherein said mountable traversing carriage comprises:
a first end plate coupled to a first clamp;
a second end plate coupled to a second clamp;
a connector for connecting the first end plate to the second end plate;
a mid plate movably mounted to the connector and arranged between the first end plate and the second end plate;
a saddle mounted to the mid plate and having a third clamp;
2) rigidly attaching the first end plate to the workpiece by activating the first clamp;
3) rigidly attaching the second end plate to the workpiece by activating the second clamp;
4) after steps 2) and 3), using a traversing device to propel the mid plate along an axis of the workpiece;
5) after step 4), deactivating the first clamp and second clamp and activating the third clamp;
6) after step 6), using the traversing device to propel the first and second end plates along the axis of the workpiece.

8. The method of claim 7, wherein the connector is a ball screw.

9. The method of claim 8, wherein the traversing device is a motor attached to one of the end plates, the motor being used for rotating the connector along a linear axis of the connector.

10. A method of wrapping a pipe, comprising the steps of:
1) mounting the mountable traversing carriage of claim 1 with a wrapping device, wherein said wrapping device comprises:
a winder for rotating around the pipe;
a tape pad equipped with a quantity of tape attached to said winder;
2) locking the first clamp and the second clamp on the pipe; and
3) traversing the mid plate along the pipe by activating the traversing device.

11. A method for manufacturing a mountable traversing carriage comprising the step of:
1) connecting a first end plate having a first clamp, a second end plate having a second clamp, and a mid plate having a third clamp, the mid plate being located between the first end plate and the second end plate, with a connector; and
2) equipping the first end plate with a traversing device for advancing the mid plate along a workpiece when the first clamp and the second clamp are locked onto the workpiece, and for advancing the first end plate and the second end plate along the workpiece when the third clamp is locked onto the workpiece.
